(19) United States
(12) Patent Application Publication
(10) Pub. No.: US 2005/0223012 A1
(43) Pub. Date: Oct. 6, 2005

(54) Document management server, document management system, document management method, document management program and storage medium storing that document management program

(75) Inventor: Takayoshi Ohkohchi, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/096,918

(22) Filed: Mar. 31, 2005

(30) Foreign Application Priority Data
Mar. 31, 2004 (JP) 2004-104662

(51) Int. Cl. G06F 17/30

(52) U.S. Cl. 707/10

(57) ABSTRACT

In a document management system, a document management server storing in its data storage portion a document management means, document files, and an entry operator list linking thereto; a computer; and a printer are connected via a communications line. The entry operator list is arranged such that a condition for “trial printing” and a maximum number of “official printouts” can be specified. If the content stored in the entry operator list indicates that even one entry operator has not completed entry, then the document management means sets a condition for “trial printing” in a printer driver, whereas if the content stored in the entry operator list indicates that all entry operators have competed entry, then the document management means stores in the entry operator list a number of “official printouts” set and printed by the printer driver, and prohibits printing which exceeds a cumulative number of “official printouts”.

### CROSS REFERENCE TO RELATED APPLICATIONS

This application claims priority under 35 U.S.C. §119(a) to Patent Application No. 2004-104662 filed in Japan on Mar. 31, 2004, the entire content of which is hereby incorporated by reference.

### BACKGROUND OF THE INVENTION

1. Field of Invention

The present invention relates to a document management server that can be connected to a terminal device via a communications line, specifically to a document management system in which this document management server, at least one terminal device, and at least one output device are connected by a communications line; a document management method for managing documents using document files and an entry operator list which stores conditions under which entry operators entered the document files; and a document management program that executes each step in this document management method, as well as a storage medium on which this program is stored.

2. Conventional Art

It is not uncommon for several people to create a single document, and in recent years technologies for automatically performing a process of integrating a plurality of created manuscripts into a single document using uniform page numbering, etc., in a network environment have been proposed, such as, for example, JP 3097562 (hereafter referred to as “Patent Document 1”) and JP 2002-366542A (hereafter referred to as “Patent Document 2”).

Patent Document 1 describes a printing control device that integrates data of a plurality of manuscripts sent from one or more client machines into a single printing job based on prerecorded prescribed integration definition information (layout definition information).

Patent Document 2 above describes an editing device and printing device which, by allowing a manager who oversees the entire document to check individual manuscripts and overall finish, and request corrections from individuals in charge of each manuscript, makes it possible to check an integrated image before printing and thereby efficiently request corrections from individuals in charge of each manuscript.

However, the device according to Patent Document 1 poses a problem in that all the manuscripts are printed as soon as they are collected and cannot be printed at an intermediate stage, making it impossible to check the printing image at an intermediate stage.

The device according to the Patent Document 2 poses a problem in that an administrator is needed to oversee the entire document. Moreover, individuals in charge of each manuscript are unable to check progress of creation of each document, so if the document is printed before all individuals in charge have completed their documents, only an incomplete document can be printed until the final and completed document data is achieved, creating a problem in that wasteful printing will occur.

### SUMMARY OF THE INVENTION

The present invention has as an object to provide a document management server, a document management system, a document management method, and a document management program and a storage medium for storing the document management program, wherein non-wasteful, efficient printing can be performed in accordance with progress of document file creation, without installing an administrator, in cases where a plurality of individuals share in the creation of a single document.

A document management server according to an embodiment of the present invention can be connected via a communications line to at least one terminal device, and can store one or more document files and at least one entry operator list which stores an entry status for each entry operator entering the document file or files, and comprises a management function for managing the document file or files and the entry operator list; and a communication function for communication with the terminal device; wherein the management function processes the document file or files and/or the entry operator list in response to an operation request from the terminal device regarding the document file or files and/or the entry operator list, and outputs, to the terminal device, the document file or files in response to an output request from the terminal device, limiting the output conditions in accordance with the status stored in the entry operator list.

In accordance with these features of the present invention, the management function can limit the output conditions in accordance with the document creation status, which is stored in the entry operator list. For example, if output is printed output, the management function can limit the settings of the corresponding printer driver (e.g., number of printouts to print, printing output format, etc.). This way, it is possible to prevent wasteful printing. The management function can further perform non-wasteful, efficient printing in accordance with the progress of document file creation, without installing an administrator, in cases where a plurality of individuals share in the creation of a single document.

Further, a document management system according to another embodiment of the present invention comprises a document management server that can store one or more document files and at least one entry operator list which stores an entry status for each entry operator entering the document file or files, the document management server having a management function for managing the document file or files and the entry operator list; and a web server function; at least one terminal device having a web browser function; and an output device driver function; and at least one output device; wherein the document management server, the terminal device, and the output device can be connected via a communications line; and wherein the management function of the document management server processes the document file or files and/or the entry operator list in accordance with an operation request from the terminal device regarding the document file or files and/or the entry operator list and outputs, to the terminal device, the document file or files in response to an output request from the terminal device, limiting the output settings of the output device driver function in accordance with the status stored in the entry operator list. In this case, the output device may be a printer, and the output device driver function may be a printer driver.

In accordance with these features of the present invention, the management function, the document file, and the entry operator list are all kept in the document management server, so a document management system can be created that has outstanding versatility, since commercially-available terminal devices (e.g., personal computers) may be used as the terminal devices connected to the document management server. The management function can limit the output conditions in accordance with the document creation status, which is stored in the entry operator list. For example, if output is printed output, the management function can limit the settings of the corresponding printer driver (e.g., number of printouts to print, printing output format, etc.). This way, it is possible to prevent wasteful printing.

Further, a document management system according to yet another embodiment of the present invention comprises a document management server that can store one or more document files and at least one entry operator list which stores an entry status for each entry operator entering the document file or files; at least one terminal device having a management function for managing the document file or files and the entry operator list, which are stored in the document management server; and an output device driver function; and at least one output device; wherein the document management server, the terminal device, and the output device can be connected via a communications line; and wherein the management function processes the document file or files and/or the entry operator list stored in the document management server via the communications line in accordance with an operation request regarding the document file or files and/or the entry operator list, and, in response to an output request, obtains the document file or files from the document management server via the communications line and outputs the obtained document file or files to the output device, limiting the output settings of the output device driver function in accordance with the status stored in the entry operator list. In this case, the output device may be a printer, and the output device driver function may be a printer driver.

In accordance with these features of the present invention, the burden on the document management server is reduced, because each terminal device is provided with the management function, while the document management server is only provided with the document file and entry operator list. The management function can limit the output conditions in accordance with the document creation status, which is stored in the entry operator list. For example, if output is printed output, the management function can limit the settings of the corresponding printer driver (e.g., number of printouts to print, printing output format, etc.). This way, it is possible to prevent wasteful printing.

In a document management system according to the present invention, the entry operator list may be arranged such that a condition for “trial printing” can be set; and the management function may set the condition for “trial printing” in the printer driver if the content stored in the entry operator list indicates that any of the entry operators has not completed entry. With this configuration, only trial printing is possible until completion of the entire document, making it possible to save toner and paper. Waste in terms of accidental official printing is thereby prevented until a document is completed. More specifically, the “trial printing” condition may be configured to allow selection of at least one of the following: adding a “draft” watermark; limiting a number of printouts to “one”; specifying an “N-Up” in which a plurality of pages are printed on a single sheet of paper; and specifying duplex printing. Limiting the conditions for trial printing in this way clarifies that a printed printout is a “trial printout” until the entire document is complete, and saves paper.

Further, a document management system according to the present invention may also be configured so that the entry operator list is arranged such that a maximum number of “official printouts” can be specified; and if the content stored in the entry operator list indicates that all entry operators have completed entry, then the management function stores in the entry operator list a number of “official printouts” set in the printer driver and printed out, and prohibits printing which cumulatively exceeds the maximum number of “official printouts”. Specifying a maximum “official printing” number of printouts in this manner makes it possible to limit “official printing” of a wastefully large number of printouts.

A document management system according to the present invention may also be configured so that the document management server is further provided with a notification function; the entry operator list is arranged such that it can store terminal device information corresponding to each entry operator; and the management function causes the notification function to notify the terminal device(s), corresponding to the entry operator(s), of content corresponding to the status stored in the entry operator list. A document management system according to the present invention may also be configured so that the document management server is further comprises a notification function; the entry operator list is arranged such that it can store terminal device information corresponding to each entry operator; and the management function causes the notification function to notify the terminal device(s), corresponding to the entry operator(s), of content corresponding to the status stored in the entry operator list. Notifying terminal device(s) corresponding to entry operator(s) of content corresponding to the status stored in the entry operator list in this manner makes it possible for each entry operator to respond to the entry status of other entry operators in an appropriate fashion.

A document management system according to the present invention may also be configured so that the entry operator list is arranged such that a number of “official printouts” can be stored for each entry operator; and if the content stored in the entry operator list indicates final completion of entry and that at least one printout is stored as the number of “official printouts”, then the management function uses the notification function to notify the terminal device(s) of entry operator(s) for whom a number of “official printouts” is stored that their “official printouts” are outdated and clears the storage of the number of “official printouts”. Thus, if the stored content of the entry operator list indicates final completion of entry, and if at least one printout is stored as the number of “official printouts” at that moment, the notification function notifies the terminal device(s) of the entry operator(s) for whom a number of “official printouts” is stored that their “official printouts” are outdated. If re-editing is performed after official printing, this makes it possible to notify entry operators who have performed official printing before the re-editing that their official printouts are outdated, making it possible to maintain official printing completely up-to-date.

A document management system according to the present invention may also be configured so that the entry operator list is arranged such that a number of “official printouts” can be stored for each entry operator; and if the stored content in the entry operator list indicates final completion of entry for all entry operators and that a cumulative number of “official printouts” has reached the maximum number of “official printouts”, the management function uses the notification function to notify the terminal device(s) of entry operator(s) for whom the number of “official printouts” is zero of the number of “official printouts” for each entry operator. Such a configuration eliminates wasteful official printing and lets individuals who have not performed “official printing” know from whom they should get printing results.

Furthermore, a document management system according to the present invention may be configured so that the entry operator list is arranged such that a document creation deadline can be set; and when the creation deadline has passed, the management function treats a created document as though all entry operators had completed entry. Treating documents in this manner makes it possible to manage deadlines for documents even when one of the entry operators is away on business, for example, and the document is left incomplete for an extended period of time, in cases where a plurality of entry operators share in the creation of a single document.

In this case, the document management server may further comprise a notification function; and if entry by all entry operators has not been completed by a certain period prior to the creation deadline, then the management function sends to the terminal devices of all entry operators, or to the terminal device(s) of that/those operator(s) who has/have not completed document entry a warning that the document has not been completed. Sending this kind of warning makes it possible to notify entry operators who have not completed document entry that the creation deadline is approaching.

A document management method for managing documents uses one or more document files and at least one entry operator list that stores an entry status for each entry operator entering the document file or files, and comprises associating the document file or files with the entry operator list; processing the document file or files and/or the entry operator list in response to an operation request instruction from a user regarding the document file or files and/or the entry operator list; and limiting an output condition in accordance with the status stored in the entry operator list, in response to an output request instruction for the document file or files from the user.

In accordance with these features of the present invention, it is possible to limit the output conditions in accordance with the document creation status, which is stored in the entry operator list. For example, if output is printed output, the management function can limit the settings of the corresponding printer driver (e.g., number of printouts to print, printing output format, etc.). This way, it is possible to prevent wasteful printing.

The document management method according to the present invention may be configured so that the entry operator list is arranged such that a condition for “trial printing” can be set; and the document management method further comprises setting the condition for “trial printing” as the output condition if the content stored in the entry operator list indicates that any of the entry operators has not completed entry. With this configuration, only trial printing is possible until completion of the entire document, making it possible to save toner and paper. Waste in terms of accidental official printing is thereby prevented until a document is completed.

Further, the document management method according to the present invention may be configured so that the entry operator list is arranged such that a maximum number of “official printouts” can be specified; and the document management method further comprises, storing, in the entry operator list, a number of “official printouts” that have been printed when the content stored in the entry operator list indicates that all entry operators have completed entry; and prohibiting printing which cumulatively exceeds the maximum number of “official printouts”. Specifying a maximum number of printouts for “official printing” in this manner makes it possible to limit “official printing” of a wastefully large number of printouts.

A document management method according to the present invention may also be configured so that the entry operator list is arranged such that terminal device information corresponding to each entry operator can be stored; and the document management method further comprises sending notifications in accordance with status stored in the entry operator list to the terminal device(s) corresponding to the entry operator(s). Notifying terminal device(s) corresponding to entry operator(s) of content corresponding to the status stored in the entry operator list in this manner makes it possible for each entry operator to respond to the entry status of other entry operators in an appropriate fashion.

A document management method according to the present invention may also be configured so that the entry operator list is arranged such that a number of “official printouts” can be stored for each entry operator; and the document management method further comprises notifying the terminal device(s) of entry operator(s) for whom a number of “official printouts” is stored that their “official printouts” are outdated and clearing the storage of the number of “official printouts”, if the content stored in the entry operator list indicates final completion of entry and that at least one printout is stored as the number of “official printouts”. Thus, if the stored content of the entry operator list indicates final completion of entry for that individual, and if at least one printout is stored as the number of “official printouts” at that moment, the terminal device(s) of the entry operator(s) for whom a number of “official printouts” is stored is notified that their “official printouts” are outdated. If re-editing is performed after official printing, this makes it possible to notify entry operators who have performed official printing before the re-editing that their official printouts are outdated, making it possible to maintain official printing completely up-to-date.

A document management method according to the present invention may also be configured so that the entry operator list is arranged such that a number of “official printouts” can be stored for each entry operator; and the document management method further comprises notifying the terminal device(s) of entry operator(s) for whom the number of “official printouts” is zero of the number of “official printouts” for each entry operator, if the stored content in the entry operator list indicates final completion of entry for all entry operators and that a cumulative number of “official printouts” has reached the maximum number of official printouts. Such a configuration eliminates wasteful official printing and lets individuals who have not performed “official printing” know from whom they should get printing results.

According to the present invention, the document management method in the above configuration may be provided as a document management program to be executed by a computer. This document management program may be provided stored in a storage medium which can be read by a computer.

### BRIEF DESCRIPTION OF THE DRAWINGS

FIG. 1 is a diagram of an overall document management system comprising a document management means, a document file and an entry operator list linked thereto, associated with an embodiment of the present invention.

FIG. 2 is a diagram illustrating an entry operator list associated with an embodiment of the present invention.

FIG. 3 is a diagram illustrating an entry operator list associated with an embodiment of the present invention.

FIG. 4 is a diagram showing an example of printing associated with the status (document creation progress) registered in the entry operator list associated with an embodiment of the present invention.

FIG. 5 is a flowchart showing the overall process flow for a document management system associated with an embodiment of the present invention.

FIG. 6 is a flowchart showing a procedure for a check-in (final saving) process for a document management system associated with an embodiment of the present invention.

FIG. 7 is a flowchart showing a procedure for a printing process for a document management system associated with an embodiment of the present invention.

FIG. 8 is a flowchart showing a procedure for a document creation deadline process for a document management system associated with an embodiment of the present invention.

FIG. 9 is a diagram showing of an overall document creation deadline associated with another embodiment of the present invention.

FIG. 10 is a diagram showing an example of a case where a single document is composed of a plurality of document files in a document management system associated with the present invention.

FIG. 11 is a diagram showing an example of a case where a plurality of documents and document files are managed simultaneously in a document management system associated with the present invention.

### DESCRIPTION OF THE PREFERRED EMBODIMENTS

Below follows a description of an embodiment of the present invention, with reference to the drawings. Note that the embodiment described below is one specific example of the present invention, and does not limit the technical scope of the present invention.

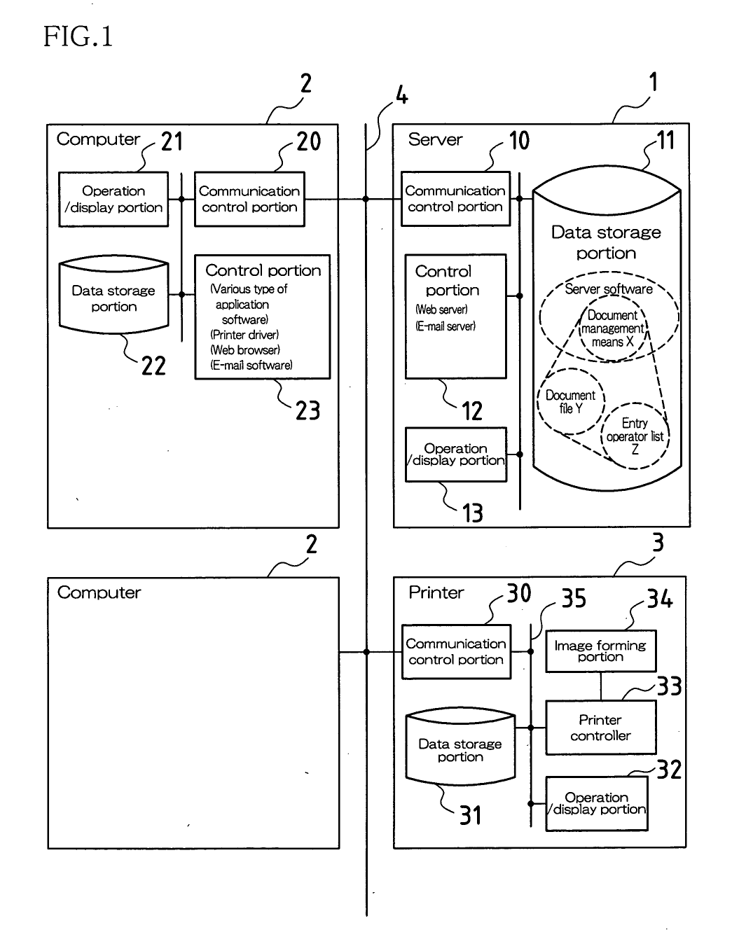

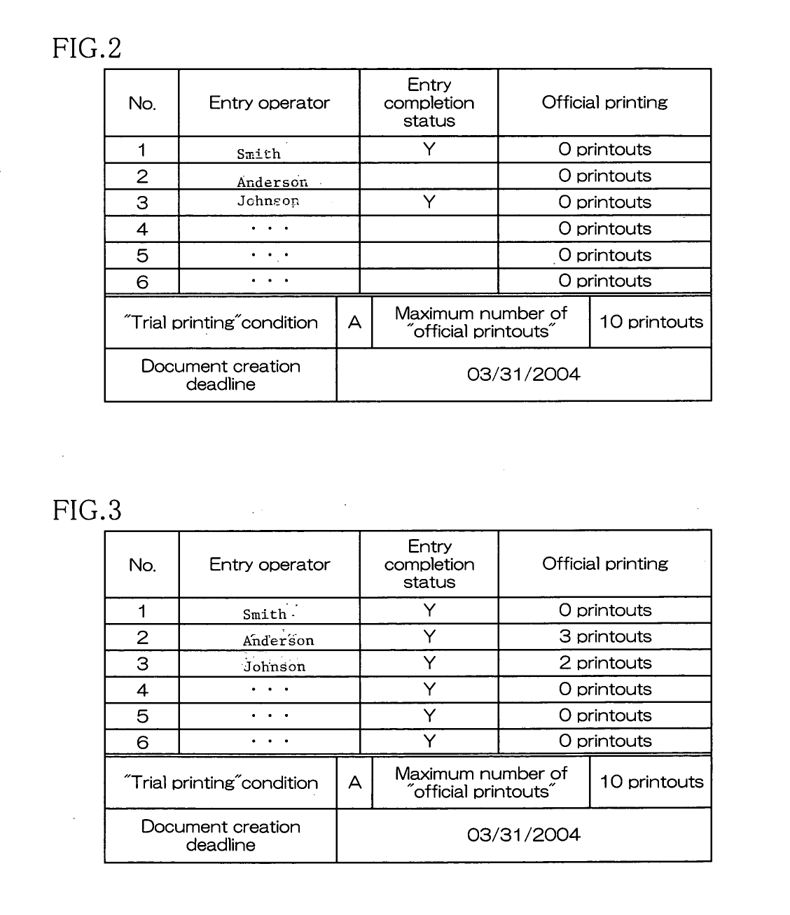

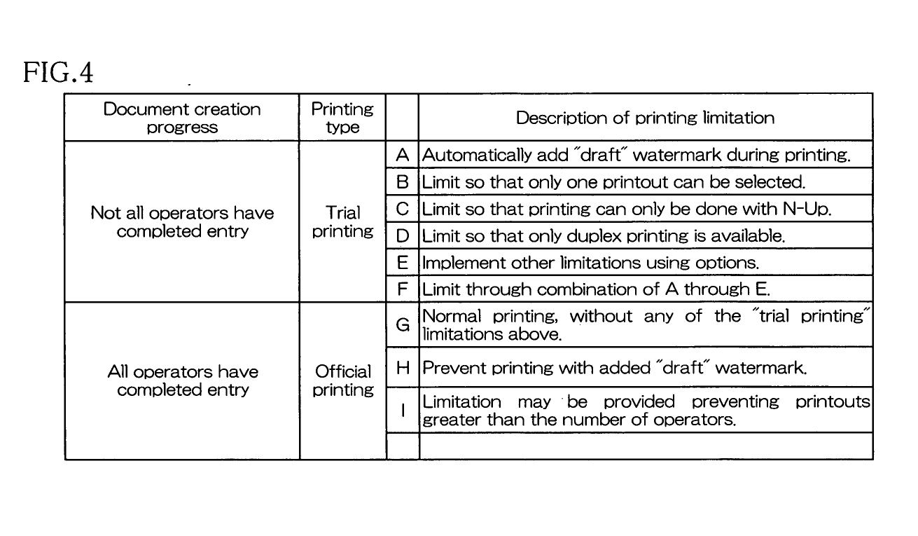

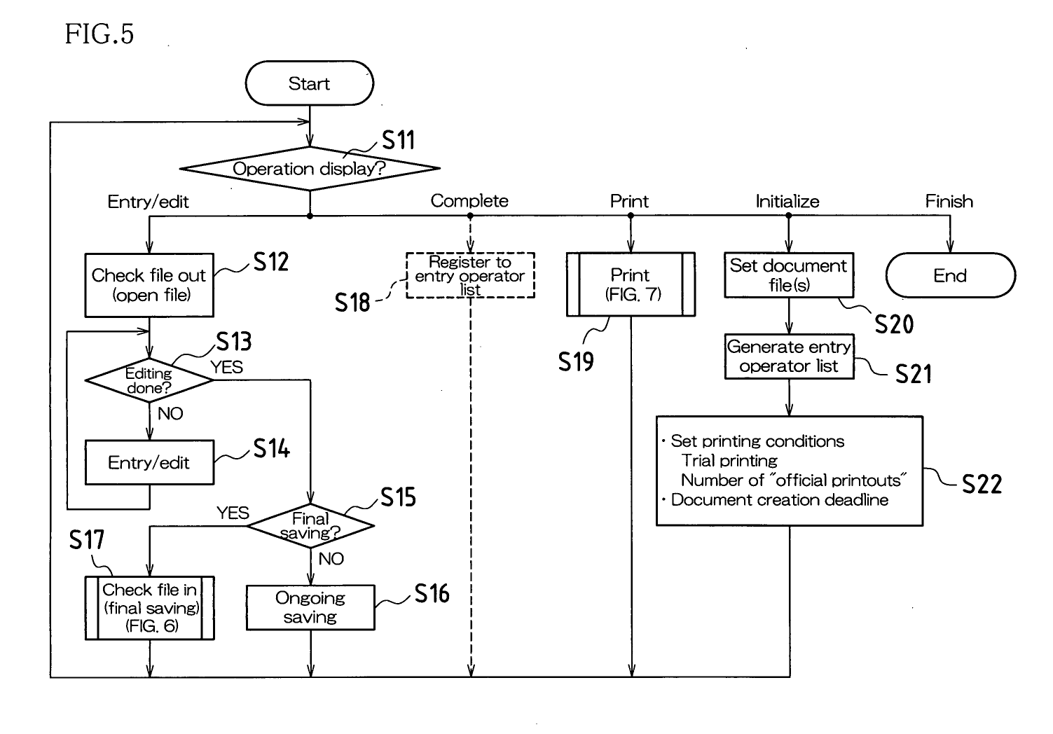

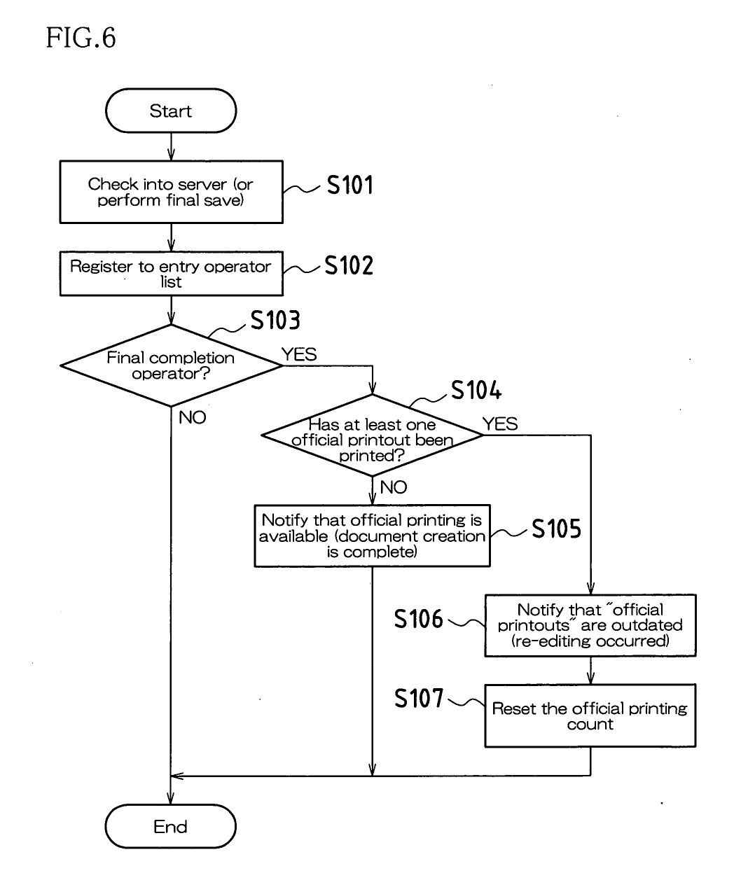

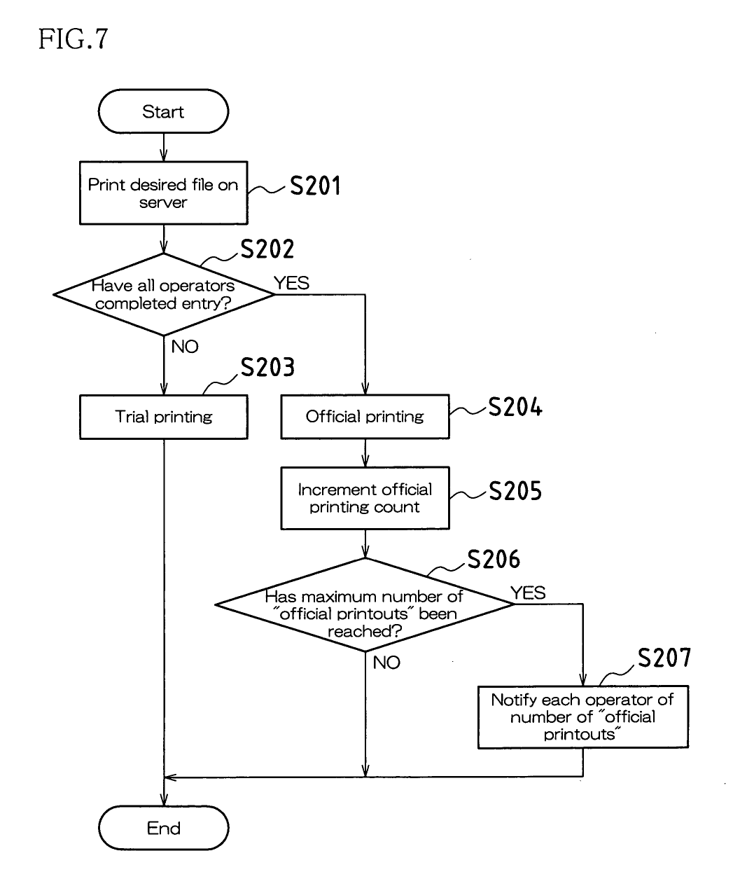

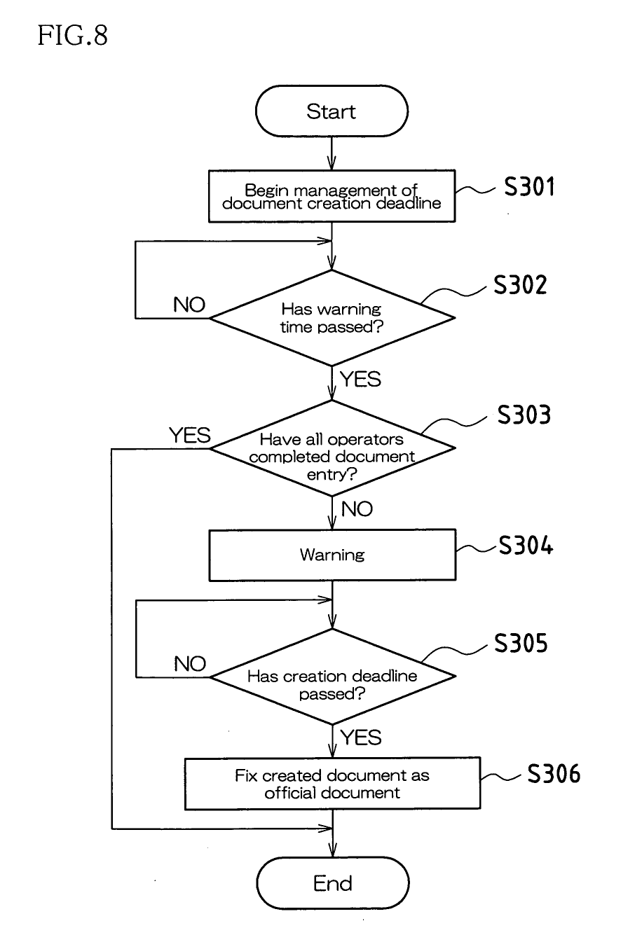

FIG. 1 is a diagram of a document management system comprising a document management means X, a document file Y and an entry operator list Z linked thereto, associated with an embodiment of the present invention; FIG. 2 and FIG. 3 are diagrams illustrating the entry operator list Z associated with an embodiment of the present invention; FIG. 4 is diagram showing an example of printing associated with statuses (document creation progress) registered to an entry operator list associated with an embodiment of the present invention; FIG. 5 is a flowchart showing an entire process flow for a document management system associated with an embodiment of the present invention; FIG. 6 is a flowchart showing a procedure for a check-in (final saving) process for a document management system associated with an embodiment of the present invention; FIG. 7 is a flowchart showing a procedure for a printing process for a document management system associated with an embodiment of the present invention; and FIG. 8 is a flowchart showing a procedure for a document creation deadline process for a document management system associated with an embodiment of the present invention.

—Description of the Overall Configuration of a Document Management System—

Below follows a description of a document management system comprising a document management means X, a document file Y and an entry operator list Z linked thereto, with reference to FIG. 1.

The overall configuration comprises a document management server (hereafter referred to simply as a “server”) 1, at least one computer 2, and at least one printer 3, all connected via a communications line 4. The computer 2 is used by a document creator. The document management means X may exist independently as server software.

<Description of the Server 1>

The server 1 is configured with a communication control portion 10 which controls communication with the computer 2 and the printer 3; an operation/display portion 13 comprising a CRT display, a keyboard and a mouse for example; a data storage portion 11 such as a hard disk; and a control portion 12 comprising an MPU, a main memory, and their peripheral devices. The document file Y and the entry operator list Z linked thereto are stored in the data storage portion 11. Note that the document file Y may internally contain the entry operator list Z.

The server 1 is a device provided with a so-called web server function, and sends to the computer 2 from the data storage portion 11 HTML data and image data or the like, corresponding to URLs sent from the computer 2, responds to requests from the computer 2 to the data storage portion 11 to upload data and requests to modify data in the data storage portion 11, and executes these processes in accordance with a program such as a CGI registered in advance. This web server function is one portion of a notification means. The server 1 is a device which is provided with a so-called electronic mail server function, and acts as a general communication means for sending and receiving electronic mail to and from the computer 2. A detailed configuration of the server 1 is commonly known, so a detailed description thereof is omitted here. The document management means X, which is server software, controls association and linked operation of the document file Y and the entry operator list Z.

<Description of the Computer 2>

The computer 2 is configured with a communication control portion 20 which controls communication with the server 1 and the printer 3; an operation/display portion 21 comprising a CRT display, a keyboard, a mouse, etc.; a data storage portion 22 such as a hard disk drive; and a control portion 23 comprising an MPU, a main memory, and their peripheral devices. A printer driver, which is a program for controlling transmission of printing data to the printer 3, word processing, spreadsheet, and other application software are installed in the data storage portion 22 and are placed as needed in the main memory, which is not shown, in the control portion 23 for execution. A detailed configuration of the computer 2 is commonly known, so a detailed description thereof is omitted here. Note that the printer driver is provided with a function for generating printing data from specified document data and sending this to the printer 3, in accordance with printing instructions from the application software.

<Description of the Printer 3>

The printer 3 includes a communication control portion 30, a data storage portion 31, an operation/display portion 32 such as an LCD touch panel, a printer controller 33, and an image forming portion 34. These are connected by a dedicated bus 35 such that they may communicate with one another.

The communication control portion 30 controls communication with the computer 2 and controls transmission of data between the computer 2 and the printer controller.33. The data storage portion 31 is a storage device such as a hard disk, and stores all types of data handled by the printer controller 33, etc. The operation/display portion 32 is an input/output device such as an LCD touch panel. The printer controller 33 outputs control signals to each actuator of the image forming portion 34, according to printing data sent from the computer 2. These processes are executed by the MPU and its peripheral devices (not shown) of the printer controller 33, in accordance with prescribed programs registered in advance. The image forming portion 34 comprises a variety of actuators for forming images and forms images on paper or the like, according to control signals from the printer controller 33.

—Description of a Process Procedure of a Document Management System—

Next follows a description of a procedure for a process of a document management system according to the above configuration, with reference as needed to the flowcharts shown in FIG. 5 to FIG. 8 and the explanatory drawings shown in FIG. 2 to FIG. 4. The following description is of a case where several people share in the creation of a single document, and trial printing of the document during creation and official printing of the final document are performed.

To start with, a flow of an entire process of the document management system according to the present embodiment is described in accordance with the flowchart shown in FIG. 5, and then a final saving process, a printing process, and a creation deadline process for a created document are described, referring to the flowcharts shown in FIG. 6 to FIG. 8.

<Description of a Flow of an Entire Process>

In the document management system according to the present embodiment, entry/edit, completion, printing, and initialization processes are executed in accordance with operation instructions from an entry operator.

The entry operator of a document accesses a document management means X via a web browser from a computer 2 and gives instructions for various processes from the access screen (step S11).

If the instruction is “Entry/edit”, then in order to perform some kind of operation on the document file in question, a file is checked out, the corresponding document file is opened (step S12), and some type of entry or editing operation is performed (step S13, step S14). If, during this operation, editing is completely terminated and an editing termination operation is performed (i.e., if the answer is Yes at step S13), the document management means X checks whether or not editing is completely terminated or not (step S15) and moves on to a final saving process described below (step S17) after the entry operator has performed an entry completion operation (check-in) (i.e., if the answer is Yes at step S15). However, if the editing termination operation is a temporary termination operation, then the document file is saved in an ongoing status (step S16) if editing is to be continued later (i.e., the answer is No at step S15). An ongoing status here means that a “Y” is not entered in the field “Entry completion status” in the entry operator list Z shown in FIG. 2, described below. Incidentally, a final saving process is a process whereby a “Y” is entered in the entry completion status field in the entry operator list Z shown in FIG. 2.

Note that if, after the entry operator saves a document as ongoing, he or she decides in the end that the document may be finally saved, only the completion process needs to be performed by instructing “Complete” from the above access screen. This registers the completion in the entry operator list Z. Specifically, a “Y” is entered in the “Entry completion status” field in the entry operator list Z shown in FIG. 2 (step S18).

However, if “Print” is instructed from the above access screen, the procedure enters a printing process described below (step S19).

If “Initialize” is instructed from the above access screen, a document file for which a desired format has been selected is specified as a document file to be created by all creators (step S20), an entry operator list Z is created corresponding to the document file (step S21), and printing conditions and a creation deadline (also described below) provided to the entry operator list Z are set (step S22).

This concludes the flow of the entire process of the document management system.

Next, procedures for a final saving process, a printing process, and a creation deadline process are described, with reference to the flowcharts in FIG. 6 to FIG. 8.

<Description of a Final Saving Process>

A procedure for a check-in (final saving) process is described, with reference to the flowchart in FIG. 6.

An entry operator terminates entry and checks in a document in step S101, and registers completion of entry in the entry operator list Z in the following step S102.

However, access privileges for access to files on the server 1 are granted to individual users and login is therefore required, so it can be determined by the document management means X on the server 1 that a document has been checked in. Accordingly, registration to the entry operator list Z may be made an automatic and linked operation by the document management means X on the server 1. In this case, work can be performed without being aware of the existence of the entry operator list Z. However, in this case, checking in means completing the entry/edit operation by the entry operator. If checking in means ongoing saving instead of completion of the entry/edit operation, then a separate function should be provided which means final check-in.

FIG. 2 and FIG. 3 are configuration diagrams which show examples of entry operator lists Z.

The entry operator list Z contains the entry operators' names (or login user names), registered in advance, that are required for entry, and is where entry completion status will be registered. The entry operator list Z comprises the fields “Entry operator”, “Entry completion status”, and “Official printing”, and it is possible to set a condition of “trial printing”, a maximum number of “official printouts”, and a creation deadline in it. Terminal device information associated with each entry operator may be stored in the entry operator list Z. Note that while it is not shown in the flow shown in FIG. 7, described below, registration to the entry operator list Z may be performed after the trial printing in step S203.

In step S103, the document management means X on the server 1 references the entry operator list Z and determines whether an entry operator currently operating is a final operation completion operator or not. Specifically, the moment a “Y” is entered in all entry completion status fields in the entry operator list Z, as shown in FIG. 3, the document management means X determines that the last entry operator is the final operation completion operator. As a result, the procedure advances to step S104 if it is the final operation completion operator, but terminates the process if it is not the final operation completion operator.

In step S104, if a determination is made that it is the final operation completion operator, a further determination is made about whether even a single official printout has been made at that point. As a result, if no official printouts have been made (i.e., the answer is No at step S104), a notification is sent either to the final entry operator or all entry operators that official printing is possible (i.e., a notification of completion of document creation) (step S105). In this case, entry operators who are working (editing) will see the notification in their web browsers, while other entry operators will receive the notification as an email, for example. The notification method in later steps is the same.

However, if, in step S103, a determination is made that the individual who checked the document into the server is the final operation completion operator and a further determination is made that at least one official printout has been made at that point in step S104, then the procedure advances to step S106, and a notification is sent to the computers 2 of entry operators for whom a number of “official printouts” has been stored that their “official printouts” are outdated. Then, in the following step S107, the number of “official printouts” is cleared. If further editing is performed after official printing, this makes it possible to notify entry operators who have performed official printing before the re-editing that their official printouts are outdated, making it possible to maintain official printing completely up-to-date.

<Description of a Printing Process>

A procedure for a printing process is described, with reference to the flowchart in FIG. 7.

In step S201, a printing operator attempts to print the desired document file Y on the common server 1.

In step S202, the document management means X on the server 1 references the entry operator list Z, determines whether all operators have finished entry or not (i.e., whether or not “Y”, indicating entry complete, has been entered in all entry completion status fields, shown in FIG. 2), and places limits on printing as shown in FIG. 4 in accordance with the progress of the document creation.

FIG. 4 shows an example of printing limitations in accordance with the progress of the document creation.

The printing limitations work according to the progress of the document creation, and are separated into cases where not all operators have completed entry and cases where all operators have completed entry. In cases where all operators have not completed entry, the only type of printing permitted is “trial printing”, while in cases where all operators have completed entry “official printing” is the type of printing which is permitted. The six types of printing limitation “A” through “F” shown in FIG. 4 are available for “trial printing”, while the three types of printing limitation “G” through “I” shown in FIG. 4 are available for “official printing”.

In the case of the entry completion status shown in FIG. 2, where not all operators have completed entry (i.e., the answer is No at step S202), the procedure advances to step S203 and only trial printing is permitted. For example, a “draft” watermark is automatically added during printing. Another example is only “one” can be selected as the number of printouts. Another example is that printing is limited to “N-Up”, in which a plurality of pages are printed on a single sheet of paper. Another example is that printing is limited to duplex printing. In this manner, trial printing is permitted with various printing limitations. A watermark here is a function for printing certain watermarking characters onto the background of a printing job.

In the present embodiment, “A” is specified as the condition for “trial printing”, as shown in FIG. 2, so a “draft” watermark is automatically added during printing. Note that it is also possible to program the document management means X so that the capabilities of the selected printer driver are obtained and an appropriate condition is employed as the condition for “trial printing”.

However, if it is determined in step S202 that all operators have completed entry (i.e., the answer is Yes), in cases where “Y” has been entered into all the entry completion status fields in the entry operator list Z as shown in FIG. 3, the procedure advances to step S204, and regular official printing is permitted, without any of the above printing limitations.

As shown in FIG. 2 and FIG. 3, in the present embodiment, a maximum number of “official printouts” is provided in the entry operator list Z which can be specified, so printing of a cumulative number of “official printouts” exceeding the maximum number of “official printouts” specified in advance is prohibited. In the case of FIG. 2 and FIG. 3, the maximum number of “official printouts” is specified as “10 printouts”, so printing in excess of 10 printouts is prohibited. Note however that it is also possible to program the document management means X in advance so that only a number of printouts equal to the number of registered entry operators can be printed.

If official printing is performed in step S204, the number of “official printouts” is counted in step S205, and the procedure advances to the following step S206.

The document management means X on the server 1 determines whether or not a maximum number of “official printouts” (or a number of printouts equal to registered entry operators, in cases where it is programmed only to print a number of printouts equal to the number of registered entry operators) has been reached. If this number has been reached (i.e., the answer is Yes), the procedure advances to step S207 and either simply announces that official printing is complete or sends notifications of the number of “official printouts” for each entry operator to the computers 2 of entry operators for whom the number of “official printouts” is zero (entry operators Nos. 1, 4, 5, and 6 in the example shown in FIG. 3).

<Description of a Document Creation Deadline Process>

A procedure for a document creation deadline process is described, with reference to the flowchart in FIG. 8.

Let us assume that a creation deadline of, for example, Mar. 3, 2004 has been entered into the creation deadline field in the entry operator list Z during the initialization process shown in FIG. 5. Let us further assume that two days before the creation deadline is set in advance as the fixed period for issuing a warning.

The document management means X monitors a timekeeping portion, which is not shown, inside the server 1 based on the set creation deadline and the fixed period, and begins deadline management for the creation deadline (step S301). The document management means X continuously compares the current time according to the timekeeping portion with a date and time two days before the set creation deadline (hereafter referred to as the “warning date and time”). When the current time passes the “warning date and time”, the document management means X checks whether or not “Y” has been entered in all entry completion status fields in the entry operator list Z (step S303). If the result is that “Y” has been entered in all the entry completion status fields (i.e., all entry operators have completed entry), (i.e., the answer is Yes at step S303), processing is terminated. However, if even one entry completion status field is missing a “Y” (i.e., at least one of the entry operators has not completed document entry) (i.e., the answer is No at step S303), a notification is sent either to the computers 2 of all the entry operators or to the computers 2 of entry operators who have not completed entry, warning that document creation has not been completed (step S304).

Next, the document management means X continues to compare the current time according to the timekeeping portion with the date and time of the creation deadline (step S305). When the current time passes the date and time of the creation deadline, the document management means X assumes that entry of the document which the entry operators are sharing has been completed, regardless of whether or not all entry operators have completed entry (step S306). Specifically, the document created up to that moment is assumed to be the official document, and subsequent printing processes are treated as “official printing”. Treating documents in this manner makes it possible to manage deadlines for documents even when one of the entry operators is away on business, etc., and the document is left incomplete for an extended period of time, in cases where a plurality of entry operators share in the creation of a single document.

This concludes the operation of the document management system according to the present embodiment.

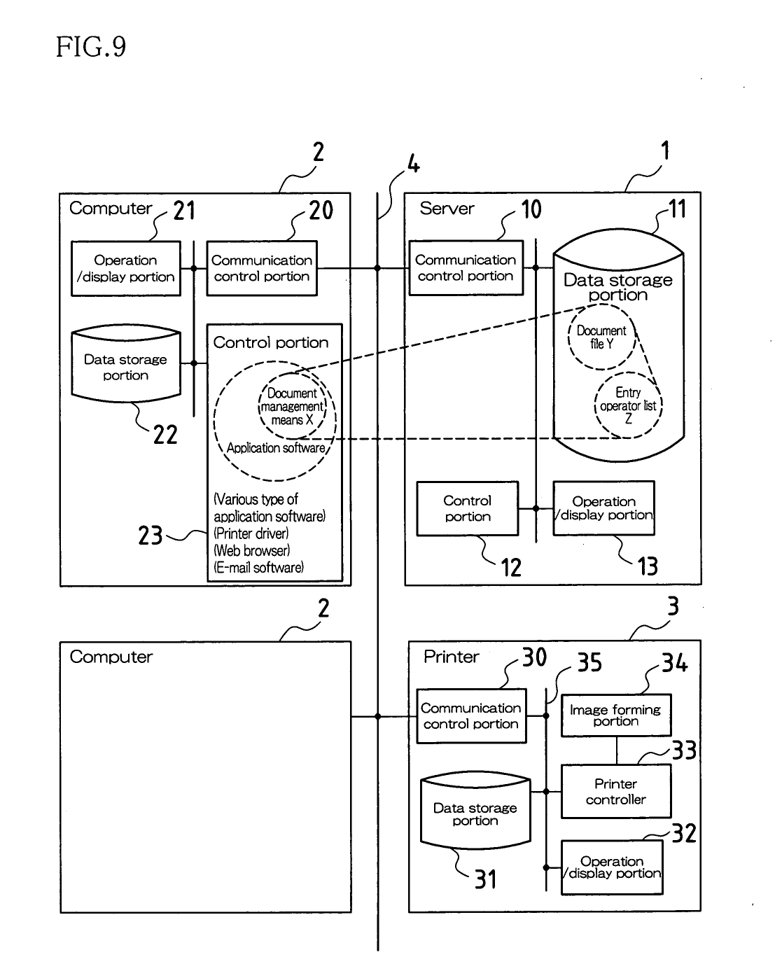

With the above embodiment, the document management system is provided with the document management means X as server software on the server 1, and the main elements are completely contained within the server 1, but it is also possible to provide this kind of document management means X in application software for each of the computers 2, as shown in FIG. 9, instead of providing the document management means X in the server software. It is also possible to provide independent application software which provides the document management means X to each of the computers 2. In this embodiment, “Check-out” and “Check-in” in FIG. 5 and FIG. 6 are equivalent to “Opening a file” and “Final saving of a file”, as shown in parentheses in the flowchart in FIG. 5.

Since a plurality of people shares in the creation of a single document under the document management system of the above embodiment, there exists the possibility that a plurality of people might simultaneously open the same document file. For this reason, it is possible to enable the document management means X to perform exclusive control which, for example, prevents other entry operators from opening a document file when one entry operator has opened the document file. Moreover, when one entry operator finishes editing and performs final saving or ongoing saving, exclusive control is cancelled, allowing other entry operators to open that document file. Performing this type of exclusive control can prevent problems arising with document files through a plurality of people opening the same file simultaneously.

Furthermore, in the above embodiment a case is described in which editing including corrections, etc., may be performed again after an entry operator has checked a file in, which is a final saving process, but since there might also be cases where it would be inconvenient to have a document improperly corrected after it has been completed, it is also possible to set such document files as read-only after their content has been fixed (i.e., after “Y” has been entered in all the entry completion status fields shown in FIG. 2). This prevents problems such as improper correction of documents which have been completely fixed.

The above embodiment is further described for a configuration in which a finally fixed document is printed and output by a printer 3, but the output format need not be limited to printing. A configuration in which, for example, a finally fixed document is attached to an e-mail and sent to a computer of an administrator specified in advance, is also possible. Even in cases of printing output, a configuration in which printing output is performed by a specific printer (for example, a specific printer used by a manager in a location away from the entry operators) is also possible. In this case, so-called private printing is preferable, in which only the manager who is the recipient can begin the printing.

Moreover, the above embodiment is described for a configuration in which a plurality of people use a single document file, but it is naturally also possible for a single document y1 to comprise a plurality of document files Y1a through Y1p. In this case, it is possible for a plurality of entry operators to simultaneously open different document files corresponding to a single document, making the exclusive control described above between these different files unnecessary. For example, if, for the document y1, one entry operator has opened the document Y1a, then another entry operator can open the document file Y1b. It is further possible in this case to associate the plurality of document files Y1a through Y1p with a single entry operator list Z1.

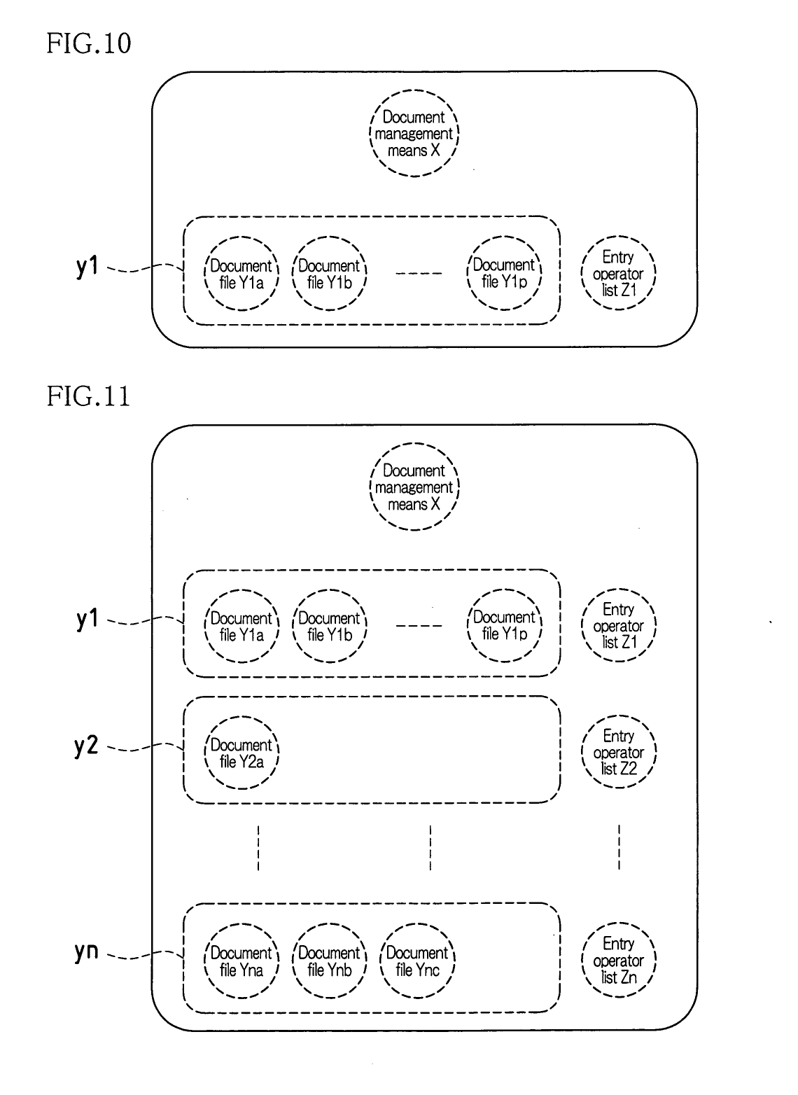

Note that while FIG. 1 and FIG. 9 show only one document file Y and entry operator list Z and FIG. 10 only shows one document y1, this is only for purposes of simplifying descriptions and drawings. In actual practice, it is naturally possible for the document management means X to simultaneously manage a plurality of documents and document files. For example, as shown in FIG. 11, even in a case where a document y1 which comprises a plurality of document files Y1a through Y1p and is associated with an entry operator list Z1, a document y2 which comprises only one document file Y2a and is associated with an entry operator list Z2, and so on through a document yn which comprises three document files Yna through Ync and is associated with an entry operator list Zn are all stored in the data storage portion 11 (see FIG. 1 and FIG. 9), the document management means X can manage all of these files.

—Description of a Document Management Program and Storage Medium—

The document management system described above can be realized by a program for managing documents using one or more document files and at least one entry operator list which stores entry status for each of these document files by entry operators.

The subject of the invention may be this program itself, but it may also be the program stored in a computer-readable storage medium.

In the present invention, for the storage media, the memory needed for performing processes with the control portion (microcomputer) 12 shown in FIG. 1, such as ROM, may be the program media, or the storage media may be program media provided with a program reading device as an external storage device, not shown, wherein the storage media is inserted and can be read. In the present invention, the data storage portion 11 shown in FIG. 1 is the program media. In any case, the stored program may be configured so that a computer accesses it and executes it, or, in any case, a system is possible in which the program is read and the read program is loaded into a program storage area, not shown, in the microcomputer, where the program is executed. A program for loading is stored in advance in a main device.

Here, the program media above may be storage media configured separably from a main device, and may be media which can fixedly support a program including tape-based media such as magnetic tape and cassette tape, magnetic disk-based media such as FDs (flexible disks) and HDs (hard disks), optical disk-based media such as CD-ROMs, MOs, MDs, and DVDs, card-based media such as IC cards (including memory cards) and optical cards, or semiconductor memory using mask ROM, EPROM, EEPROM, or flash ROM.

Further, a medium which supports programs flexibly by downloading programs from the Internet may also be possible, as the present invention is provided with a system configuration which can connect to communications networks including the Internet. Furthermore, when downloading a program from a communications network in this fashion, the program for downloading may be stored in advance in a main device, or may be installed from a separate storage medium. Note that content stored in the storage medium need not be limited to programs, but may also be data.

Moreover, in accordance with the present invention, the program itself may be the processes themselves executed by the control portion (microcomputer) 12 shown in FIG. 1, it may be a program to be read or already read by accessing a communications network, including the Internet, or it may be a program sent from the device. Furthermore, the program may also be the result or generated end-product of processes performed in the document management system based on the read program. Furthermore, the program may also be the result or generated end-product of processes performed in the document management system when sending it from the main device. Note that these need not be limited to programs, but may also be data.

Note that, in terms of industrial applicability, the storage medium which stores the document management server, the document management system, the document management program, and the document management program of the present invention may be effectively used in cases where a plurality of people share in the creation of a single document.

It should be noted that the invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A document management server that can be connected via a communications line to at least one terminal device, and can store one or more document files and at least one entry operator list which stores an entry status for each entry operator entering the document file or files, the document management server comprising:
a management function for managing the document file or files and the entry operator list; and
a communication function for communication with the terminal device;
wherein the management function processes the document file or files and/or the entry operator list in response to an operation request from the terminal device regarding the document file or files and/or the entry operator list, and outputs, to the terminal device, the document file or files in response to an output request from the terminal device, limiting the output conditions in accordance with the status stored in the entry operator list.

2. A document management system comprising:
a document management server that can store one or more document files and at least one entry operator list which stores an entry status for each entry operator entering the document file or files, the document management server having:
a management function for managing the document file or files and the entry operator list; and
a web server function;
at least one terminal device having:
a web browser function; and
an output device driver function; and
at least one output device;
wherein the document management server, the terminal device, and the output device can be connected via a communications line; and
wherein the management function of the document management server processes the document file or files and/or the entry operator list in accordance with an operation request from the terminal device regarding the document file or files and/or the entry operator list and outputs, to the terminal device, the document file or files in response to an output request from the terminal device, limiting the output settings of the output device driver function in accordance with the status stored in the entry operator list.

3. A document management system comprising:
a document management server that can store one or more document files and at least one entry operator list which stores an entry status for each entry operator entering the document file or files;
at least one terminal device having:
a management function for managing the document file or files and the entry operator list, which are stored in the document management server; and
an output device driver function; and
at least one output device;
wherein the document management server, the terminal device, and the output device can be connected via a communications line; and
wherein the management function processes the document file or files and/or the entry operator list stored in the document management server via the communications line in accordance with an operation request regarding the document file or files and/or the entry operator list, and, in response to an output request, obtains the document file or files from the document management server via the communications line and outputs the obtained document file or files to the output device, limiting the output settings of the output device driver function in accordance with the status stored in the entry operator list.

4. The document management system according to claim 2 or claim 3 wherein the output device is a printer and the output device driver function is a printer driver.

5. The document management system according to claim 4 wherein:
the entry operator list is arranged such that a condition for “trial printing” can be set; and
the management function sets the condition for “trial printing” in the printer driver if the content stored in the entry operator list indicates that any of the entry operators has not completed entry.

6. The document management system according to claim 5, wherein the “trial printing” condition is at least one of the following:
adding a “draft” watermark;
limiting a number of printouts to “one”;
specifying an “N-Up” in which a plurality of pages are printed on a single sheet of paper; and
specifying duplex printing.

7. The document management system according to claim 5 or claim 6, wherein:
the entry operator list is arranged such that a maximum number of “official printouts” can be specified; and
if the content stored in the entry operator list indicates that all entry operators have completed entry, then the management function stores in the entry operator list a number of “official printouts” set in the printer driver and printed out, and prohibits printing which cumulatively exceeds the maximum number of “official printouts”.

8. The document management system according to claim 7, wherein:
the document management server is further comprises a notification function;
the entry operator list is arranged such that it can store terminal device information corresponding to each entry operator; and
the management function causes the notification function to notify the terminal device or devices, corresponding to the entry operator or operators, of content corresponding to the status stored in the entry operator list.

9. The document management system according to claim 8, wherein:
the entry operator list is arranged such that a number of “official printouts” can be stored for each entry operator; and
if the content stored in the entry operator list indicates final completion of entry and that at least one printout is stored as the number of “official printouts”, then the management function uses the notification function to notify the terminal device or devices of entry operator or operators for whom a number of “official printouts” is stored that their “official printouts” are outdated and clears the storage of the number of “official printouts”.

10. The document management method according to claim 8, wherein:
the entry operator list is arranged such that a number of “official printouts” can be stored for each entry operator; and
if the stored content in the entry operator list indicates final completion of entry for all entry operators and that a cumulative number of “official printouts” has reached the maximum number of “official printouts”, the management function uses the notification function to notify the terminal device or devices of entry operator or operators for whom the number of “official printouts” is zero of the number of “official printouts” for each entry operator.

11. The document management system according to claim 2 or claim 3, wherein:
the entry operator list is arranged such that a document creation deadline can be set; and
when the creation deadline has passed, the management function treats a created document as though all entry operators had completed entry.

12. The document management system according to claim 11, wherein:
the document management server further comprises a notification function; and
if entry by all entry operators has not been completed by a certain period prior to the creation deadline, then the management function sends to the terminal devices of all entry operators, or to the terminal device or devices of that operator or those operators who has/have not completed document entry a warning that the document has not been completed.

13. A document management method for managing documents using one or more document files and at least one entry operator list that stores an entry status for each entry operator entering the document file or files, the document management method comprising:
associating the document file or files with the entry operator list;
processing the document file or files and/or the entry operator list in response to an operation request instruction from a user regarding the document file or files and/or the entry operator list; and
limiting an output condition in accordance with the status stored in the entry operator list, in response to an output request instruction for the document file or files from the user.

14. The document management method according to claim 13, wherein:
the entry operator list is arranged such that a condition for “trial printing” can be set; and
the document management method further comprises setting the condition for “trial printing” as the output condition if the content stored in the entry operator list indicates that any of the entry operators has not completed entry.

15. The document management method according to claim 13 or claim 14,
wherein the entry operator list is arranged such that a maximum number of “official printouts” can be specified;
wherein the document management method further comprises:
storing, in the entry operator list, a number of “official printouts” that have been printed when the content stored in the entry operator list indicates that all entry operators have completed entry; and
prohibiting printing which cumulatively exceeds the maximum number of “official printouts”.

16. The document management method according claim 15, wherein:
the entry operator list is arranged such that terminal device information corresponding to each entry operator can be stored; and
the document management method further comprises sending notifications in accordance with status stored in the entry operator list to the terminal device or devices corresponding to the entry operator or operators.

17. The document management method according the claim 16, wherein:
the entry operator list is arranged such that a number of “official printouts” can be stored for each entry operator; and
the document management method further comprises notifying the terminal device or devices of entry operator or operators for whom a number of “official printouts” is stored that their “official printouts” are outdated and clearing the storage of the number of “official printouts”, if the content stored in the entry operator list indicates final completion of entry and that at least one printout is stored as the number of “official printouts”.

18. The document management method according the claim 16, wherein:
the entry operator list is arranged such that a number of “official printouts” can be stored for each entry operator; and
the document management method further comprises notifying the terminal device or devices of entry operator or operators for whom the number of “official printouts” is zero of the number of “official printouts” for each entry operator, if the stored content in the entry operator list indicates final completion of entry for all entry operators and that a cumulative number of “official printouts” has reached the maximum number of official printouts.

19. A document management program, wherein:
the document management method according to any one of claims 13, 14, 16, 17, or 18 is stored in a program for execution by a computer.

20. A computer-readable storage medium that stores the document management program according to claim 19.
